(19) United States
(12) Patent Application Publication
(10) Pub. No.: US 2025/0240405 A1
(43) Pub. Date: Jul. 24, 2025

(54) TEMPORAL INTRA MODE PREDICTION

(71) Applicant: INTERDIGITAL CE PATENT HOLDINGS, SAS, Paris (FR)

(72) Inventors: Franck GALPIN, Thorigne-Fouillard (FR); Thierry DUMAS, Rennes (FR); Karam NASER, Mouazé (FR); Philippe BORDES, Laille (FR)

(21) Appl. No.: 18/853,573

(22) PCT Filed: Mar. 22, 2023
(86) PCT No.: PCT/EP2023/057363

§ 371 Date: Oct. 2, 2024

(30) Foreign Application Priority Data
Apr. 7, 2022 (EP) 22305482.6

(51) Int. Cl. H04N 19/105; H04N 19/139; H04N 19/176; H04N 19/513

(52) U.S. Cl. CPC H04N 19/105; H04N 19/139; H04N 19/176; H04N 19/521

(57) ABSTRACT

Intra prediction samples are determined for encoding in video encoders and decoding in video decoders using one of several embodiments. In at least one embodiment, motion information is derived to determine reference samples to use from a reference frame. The reference samples are used in an intra prediction mode to determined a prediction samples. The reference samples are used in encoding or decoding. In at least one embodiment, one of several motion models can be used to extract the motion information. The motion model, intra mode, or reference frame can be signaled from an encoder to a decoder. The signaling can use an index. The global motion model is computed at an encoder and sent in a slice header or a picture header to a corresponding decoder. In at least one embodiment, a different reference is used for a reference frame.

### CROSS-REFERENCE TO RELATED APPLICATIONS

This application claims the benefit of EPO application Ser. No. 22/305,482.6, filed Apr. 7, 2022, which is incorporated by reference herein in its entirety.

### FIELD OF THE INVENTION

At least one of the present embodiments generally relates to a method or an apparatus for video encoding or decoding, compression or decompression.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

### SUMMARY OF THE INVENTION

At least one of the present embodiments generally relates to a method or an apparatus for video encoding or decoding, and more particularly, to a method or an apparatus for improving the coding efficiency of intra prediction mode.

According to a first aspect, there is provided a method. The method comprises steps for extracting motion information for a video block; obtaining motion compensated reference samples from the motion information for the video block; determining an intra prediction from the motion compensated reference samples for the video block; and encoding at least a portion of the video block using the intra prediction.

According to a second aspect, there is provided another method. The method comprises steps for extracting motion information for a video block; obtaining motion compensated reference samples from the motion information for the video block; determining an intra prediction from the motion compensated reference samples for the video block; and decoding at least a portion of the video block using the intra prediction.

According to another aspect, there is provided an apparatus. The apparatus comprises a processor. The processor can be configured to encode a block of a video or decode a bitstream by executing any of the aforementioned methods.

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of a video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 illustrates the 67 intra prediction modes in VVC and ECM.

FIG. 2 illustrates matrix weighted intra prediction process.

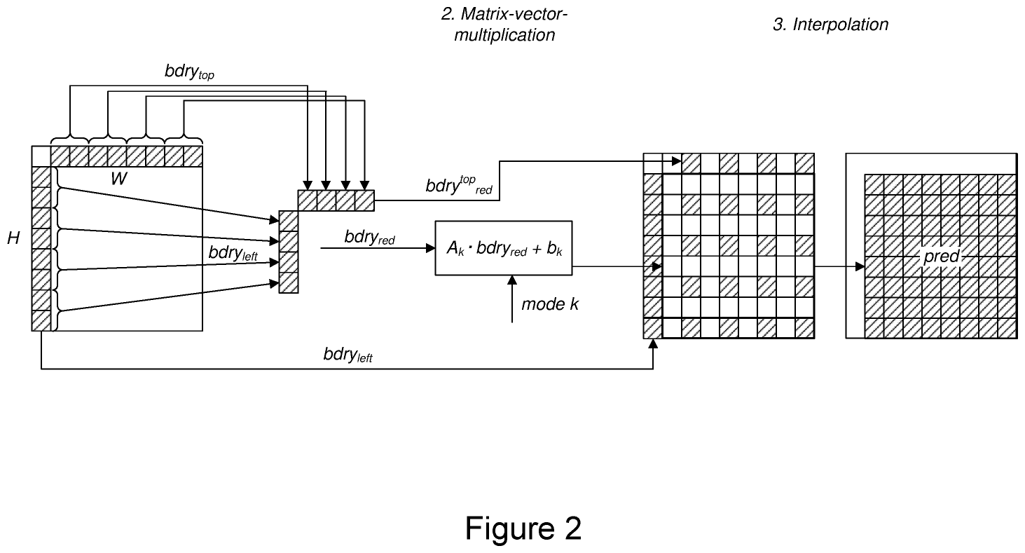

FIG. 3 illustrates the definition of samples used by PDPC applied to diagonal and adjacent angular intra modes.

FIG. 4 illustrates an example of four reference lines neighboring a prediction block.

FIG. 5 illustrates intra prediction directions.

FIG. 6 illustrates an example workflow for temporal intra prediction.

FIG. 7 illustrates an example of displaced reference samples.

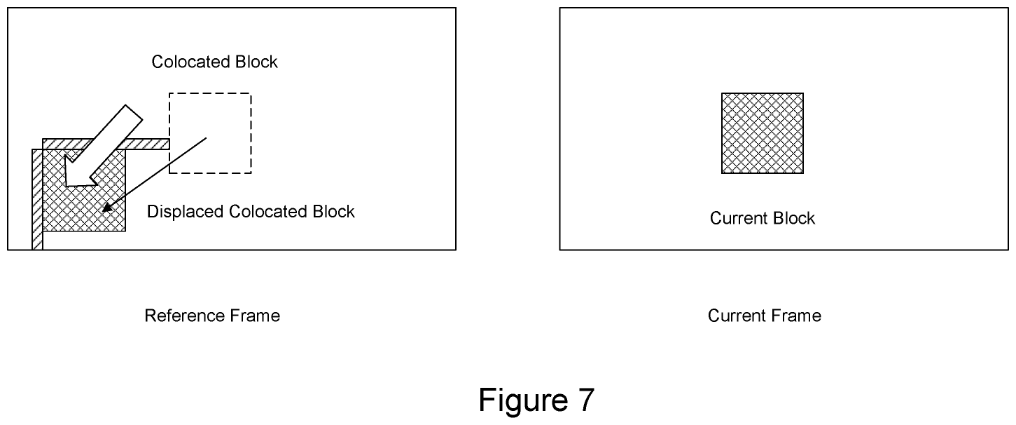

FIG. 8 illustrates an example of a simplified one pass motion compensation and filtering process.

FIG. 9 illustrates an example of new reference sample availability.

FIG. 10 illustrates an example of new intra prediction directions.

FIG. 11 illustrates an example of inner samples selection.

FIG. 12 illustrates one embodiment of a method for performing the described aspects.

FIG. 13 illustrates another embodiment of a method for performing the described aspects.

FIG. 14 illustrates one embodiment of an apparatus for implementing the described aspects.

FIG. 15 illustrates a generic video encoding or compression system.

FIG. 16 illustrates a generic video decoding or decompression system.

FIG. 17 illustrates a processor-based system for implementing the described aspects.

### DETAILED DESCRIPTION

The intra prediction is a fundamental coding tool in video compression. The encoder selects the best prediction mode and signals its index to the decoder to perform the same prediction. The intra prediction is performed using reference samples which are samples around the current block to decode already decoded. Currently, several modes are available in the VVC standard:
DC: uses reference samples to create a uniform prediction
   planar mode: uses reference samples to create a smooth prediction of the block
   directional modes: uses reference samples to “pad” these samples along a particular direction to create the prediction
   MIP (Matrix based Intra Prediction): use a linear combination of the reference samples to create a prediction

All these modes use spatial information to create the prediction.

In inter coding, prediction is created using samples from one or more reference frames.

While inter prediction gives better prediction when applicable, the prediction from the motion compensation of the block is not always suitable. Especially, for inter slice far from the reference frame (for example the last image of a GOP in random access configuration), the temporal gap can be so large than motion compensated blocks do not necessarily offer a good RD (rate distortion) compromise, even for areas common between the 2 frames. One of the reasons is that even if the global motion is correct, the local changes inside the block are too large to get a good inter prediction. As an example, the ratio of intra coded block in the first inter frame of GOP of size 32 is commonly above 50%.

Another aspect is that intra mode prediction increases the decoder complexity because it introduces latency during the decoding of inter slice: all inter and intra blocks around the current block should first be reconstructed in order to start the reconstruction of the current intra block. For low delay decoder it can introduces further latency in the pipeline. On the other hand, inter based prediction allows full parallelism of inter based reconstruction.

Intra Mode Coding with 67 Intra Prediction Modes

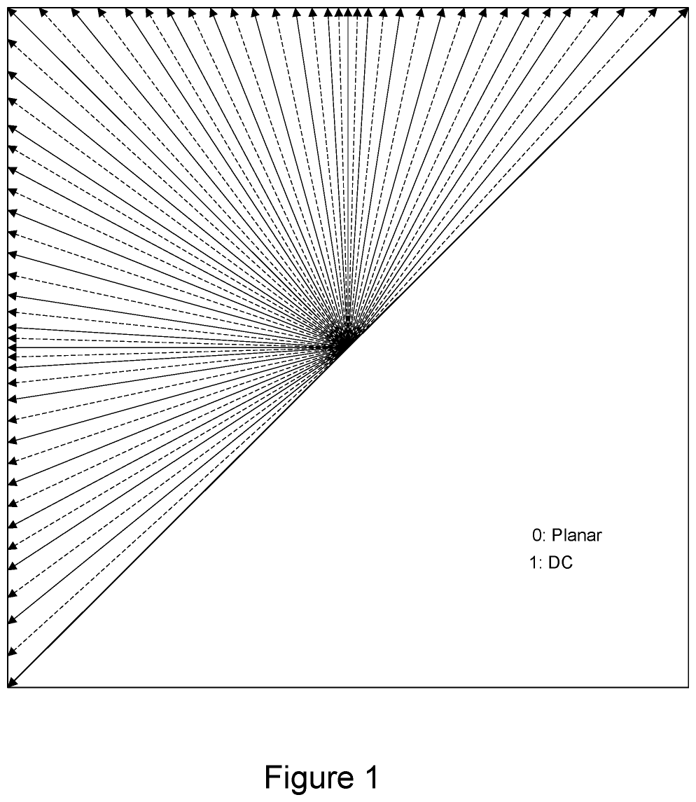

To capture the arbitrary edge directions presented in natural video, the number of directional intra modes in VVC is extended from 33, as used in HEVC, to 65. The new directional modes not in HEVC are depicted as red dotted arrows in FIG. 1, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks. Wide angle intra prediction is described elsewhere in this description.

In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### Intra Mode Coding

To keep the complexity of the most probable mode (MPM) list generation low, an intra mode coding method with 6 MPMs is used by considering two available neighboring intra modes. The following three aspects are considered to construct the MPM list:
Default intra modes
Neighbouring intra modes
Derived intra modes

A unified 6-MPM list is used for intra blocks irrespective of whether MRL and ISP coding tools are applied or not. The MPM list is constructed based on intra modes of the left and above neighboring block. Suppose the mode of the left is denoted as Left and the mode of the above block is denoted as Above, the unified MPM list is constructed as follows:
When a neighboring block is not available, its intra mode is set to Planar by default.
If both modes Left and Above are non-angular modes:
   MPM list→{Planar, DC, V, H, V−4, V+4}
If one of modes Left and Above is angular mode, and the other is non-angular:
   Set a mode Max as the larger mode in Left and Above
   MPM list→{Planar, Max, Max−1, Max+1, Max−2, Max+2}
If Left and Above are both angular and they are different:
   Set a mode Max as the larger mode in Left and Above
   Set a mode Min as the smaller mode in Left and Above
   If Max−Min is equal to 1:
      MPM list→{Planar, Left, Above, Min−1, Max+1, Min−2}
   Otherwise, if Max-Min is greater than or equal to 62:
      MPM list→{Planar, Left, Above, Min+1, Max−1, Min+2}
   Otherwise, if Max−Min is equal to 2:
      MPM list→{Planar, Left, Above, Min+1, Min−1, Max+1}
   Otherwise:
      MPM list→{Planar, Left, Above, Min−1, −Min+1, Max−1}
If Left and Above are both angular and they are the same:
   MPM list→{Planar, Left, Left−1, Left+1, Left−2, Left+2}

Besides, the first bin of the mpm index codeword is CABAC context coded. In total three contexts are used, corresponding to whether the current intra block is MRL enabled, ISP enabled, or a normal intra block.

During 6 MPM list generation process, pruning is used to remove duplicated modes so that only unique modes can be included into the MPM list. For entropy coding of the 61 non-MPM modes, a Truncated Binary Code (TBC) is used.

### Matrix Weighted Intra Prediction (MIP)

Matrix weighted intra prediction (MIP) method is a newly added intra prediction technique into WVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, which are averaging, matrix vector multiplication and linear interpolation as shown in FIG. 19.

### Position Dependent Intra Prediction Combination

In VVC, the results of intra prediction of DC, planar and several angular modes are further modified by a position dependent intra prediction combination (PDPC) method. PDPC is an intra prediction method which invokes a combination of the boundary reference samples and HEVC style intra prediction with filtered boundary reference samples. PDPC is applied to the following intra modes without signalling: planar, DC, intra angles less than or equal to horizontal, and intra angles greater than or equal to vertical and less than or equal to 80. If the current block is Bdpcm mode or MRL index is larger than 0, PDPC is not applied.

The prediction sample pred(x′,y′) is predicted using an intra prediction mode (DC, planar, angular) and a linear combination of reference samples according to the Equation 3-8 as follows:

$$ρ r e d ( {x}^{′} , {y}^{′} ) = Clip ( 0 , ( 1 << BitDepth ) - 1 , ( w L \times {R}_{- 1 , {y}^{′}} + wT \times {R}_{{x}^{′} , - 1} + ( 64 - wL - wT ) \times pred ( {x}^{′} , {y}^{′} ) + 32 ) >> 6 ) \qquad ( 3 - 8 )$$

where R_{x,-1}, R_{-1,y} represent the reference samples located at the top and left boundaries of current sample (x, y), respectively.
When PDPC is applied to DC, planar, horizontal, and vertical intra modes, additional boundary filters are not needed, as required in the case of HEVC DC mode boundary filter or horizontal/vertical mode edge filters. PDPC process for DC and Planar modes is identical. For angular modes, if the current angular mode is HOR_IDX or VER_IDX, left or top reference samples is not used, respectively. The PDPC weights and scale factors are dependent on prediction modes and the block sizes. PDPC is applied to the block with both width and height greater than or equal to 4.

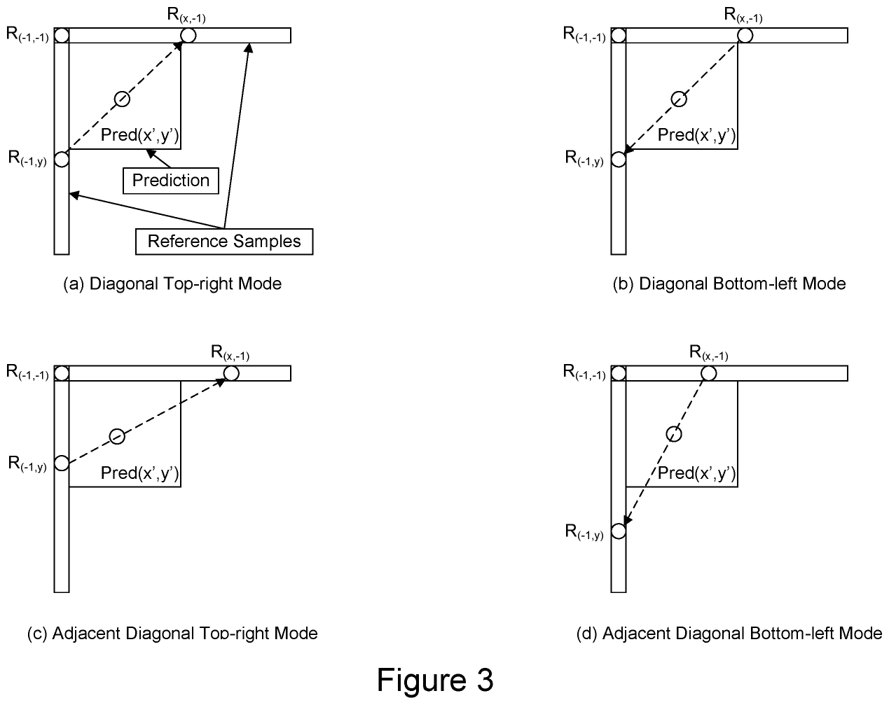

FIG. 3 illustrates the definition of reference samples (R_{x,-1} and R_{-1,y}) for PDPC applied over various prediction modes. The prediction sample pred(x′, y′) is located at (x′, y′) within the prediction block. As an example, the coordinate x of the reference sample R_{x,-1} is given by: x=x′+y′+1, and the coordinate y of the reference sample R_{-1,y} is similarly given by: y=x′+y′+1 for the diagonal modes. For the other angularg mode, the reference samples R_{x,-1} and R_{-1,y} could be located in fractional sample position. In this case, the sample value of the nearest integer sample location is used.

### Multiple Reference Line (MRL) Intra Prediction

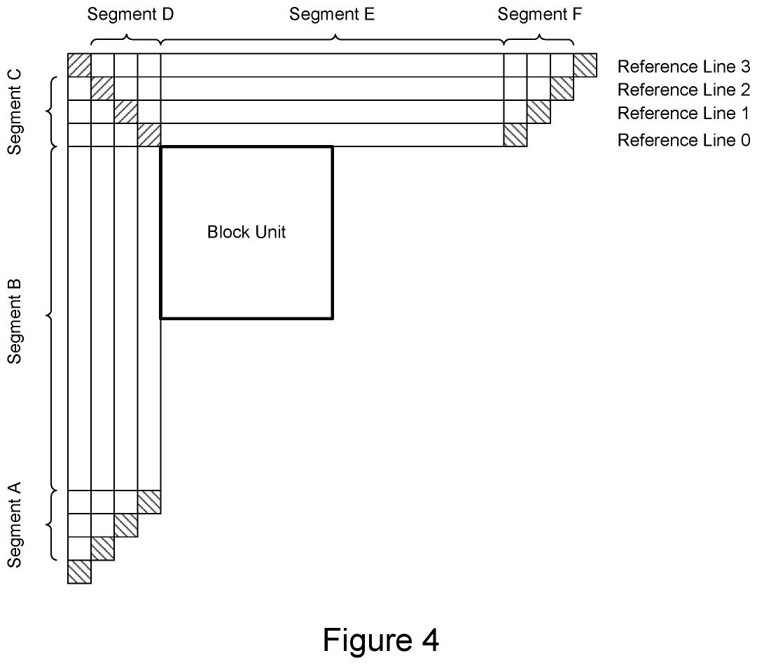

Multiple reference line (MRL) intra prediction uses more reference lines for intra prediction. In FIG. 4 an example of 4 reference lines is depicted, where the samples of segments A and F are not fetched from reconstructed neighbouring samples but padded with the closest samples from Segment B and E, respectively. HEVC intra-picture prediction uses the nearest reference line (i.e., reference line 0). In MRL, 2 additional lines (reference line 1 and reference line 3) are used.

The index of selected reference line (mrl_idx) is signalled and used to generate intra predictor. For reference line idx, which is greater than 0, only include additional reference line modes in MPM list and only signal mpm index without remaining mode. The reference line index is signalled before intra prediction modes, and Planar mode is excluded from intra prediction modes in case a nonzero reference line index is signalled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices is aligned with that of reference line index 0. MRL requires the storage of 3 neighboring luma reference lines with a CTU to generate predictions. Note that the Cross-Component Linear Model (CCLM) tool also requires 3 neighboring luma reference lines for its down-sampling filters. MRL is designed to use the same 3 lines as CCLM to reduce the storage requirements for decoders.

### Specification

### 8.4.5.2.10 Reference Sample Filtering Process

Inputs to this process are:
a variable refIdx specifying the intra prediction reference line index,
a variable nTbW specifying the transform block width,
a variable nTbH specifying the transform block height,
a variable refW specifying the reference samples width,
a variable refH specifying the reference samples height,
a variable refFilterFlag specifying the value of reference filter flag,
the (unfiltered) neighbouring samples refUnfilt[x][y], with x=−1−refIdx, y=−1−refIdx . . . refH−1 and x=−refIdx . . . refW−1, y=−1−refIdx,
a variable cIdx specifying the colour component of the current block.

Outputs of this process are the reference samples p[x][y], with x=−1−refIdx, y=−1−refIdx . . . refH−1 and x=−refIdx . . . refW−1, y=−1-refIdx.

The variable filterFlag is derived as follows:
If all of the following conditions are true, filterFlag is set equal to 1:
   refIdx is equal to 0;
   nTbW*nTbH is greater than 32;
cIdx is equal to 0;
IntraSubPartitionsSplitType is equal to ISP_NO_SPLIT;
refFilterFlag is equal to 1;
Otherwise, filterFlag is set equal to 0.

For the derivation of the reference samples p[x][y] the following applies:
If filterFlag is equal to 1, the filtered sample values p[x][y] with x=−1, y=−1 . . . refH−1 and x=0 . . . refW−1, y=−1 are derived as follows:

$$p [ - 1 ] [ - 1 ] = ( refUnfilt [ - 1 ] [ 0 ] + 2 * refUnfilt [ - 1 ] [ - 1 ] + refUnfilt [ 0 ] [ - 1 ] + 2 ) >> 2 \qquad ( 315 )$$

$$p [ - 1 ] [ y ] = ( refUnfilt [ - 1 ] [ y + 1 ] + 2 * refUnfilt [ - 1 ] [ y ] + refUnfilt [ - 1 ] [ y - 1 ] + 2 ) >> 2 \qquad ( 316 )$$

$$for y = 0 … refH - 2$$

$$p [ - 1 ] [ refH - 1 ] = refUnfilt [ - 1 ] [ refH - 1 ] \qquad ( 317 )$$

$$p [ x ] [ - 1 ] = ( refUnfilt [ x - 1 ] [ - 1 ] + 2 * refUnfilt [ x ] [ - 1 ] + refUnfilt [ x + a ] [ - 1 ] + 2 ) >> 2 \qquad ( 318 )$$

$$for x = 0 … refW - 2$$

$$p [ refW - 1 ] [ - 1 ] = refUnfilt [ refW - 1 ] [ - 1 ] \qquad ( 319 )$$

Otherwise, the reference samples values p[x][y] are set equal to the unfiltered sample values refUnfilt[x][y] with x=−1−refIdx, y=−1−refIdx . . . refH−1 and x=−refIdx . . . refW−1, y=−1−refIdx.

### 8.4.5.2.11 Specification of INTRA_PLANAR Intra Prediction Mode

Inputs to this Process are:
a variable nTbW specifying the transform block width,
a variable nTbH specifying the transform block height,
the neighbouring samples p[x][y], with x=−1, y=−1 . . . nTbH and x=0 . . . nTbW, y=−1.

Outputs of this process are the predicted samples predSamples[x][y], with x=0 . . . nTbW−1, y=0 . . . nTbH−1.

The values of the prediction samples predSamples[x][y], with x=0 . . . nTbW−1 and y=0 . . . nTbH−1, are derived as follows:

$$predV [ x ] [ y ] = ( ( nTbH - 1 - y ) * p [ x ] [ - 1 ] + ( y + 1 ) * p [ - 1 ] [ nTbH ] ) << Log 2 ( nTbW ) \qquad ( 320 )$$

$$predH [ x ] [ y ] = ( ( nTbW - 1 - x ) * p [ - 1 ] [ y ] + ( x + 1 ) * p [ nTbW ] [ - 1 ] ) << Log 2 ( nTbH ) \qquad ( 321 )$$

$$predSamples [ x ] [ y ] = ( predV [ x ] [ y ] + predH [ x ] [ y ] + nTbW * nTbH ) >> ( Log 2 ( nTbW ) + Log 2 ( nTbH ) + 1 ) \qquad ( 322 )$$

### 8.4.5.2.12 Specification of INTRA_DC Intra Prediction Mode

Inputs to this process are:
a variable nTbW specifying the transform block width,
a variable nTbH specifying the transform block height,
a variable refIdx specifying the intra prediction reference line index,
the neighbouring samples p[x][y], with x=−1−refIdx, y=0 . . . nTbH−1 and x=0 . . . nTbW−1, y=−1−refIdx.

Outputs of this process are the predicted samples predSamples[x][y], with x=0 . . . nTbW−1, y=0 . . . nTbH−1.

The values of the prediction samples predSamples[x][y], with x=0 . . . nTbW−1, y=0 . . . nTbH−1, are derived by the following ordered steps:

1. A variable dcVal is derived as follows:
When nTbW is equal to nTbH:

$$dc Val = ( {\sum }_{{x}^{′} = 0}^{nTbW - 1} p [ {x}^{′} ] [ - 1 - refIdx ] + {\sum }_{{y}^{′} = 0}^{nTbH - 1} p [ - 1 - refIdx ] [ {y}^{′} ] + nTbW ) >> ( Log 2 ( nTbW ) + 1 ) \qquad ( 323 )$$

When nTbW is greater than nTbH:

$$dc Val = ( {\sum }_{{x}^{′} = 0}^{nTbW - 1} p [ {x}^{′} ] [ - 1 - refIdx ] + ( nTbW >> 1 ) ) >> Log 2 ( nTbW ) \qquad ( 324 )$$

When nTbW is less than nTbH:

$$dc Val = ( {\sum }_{{y}^{′} = 0}^{nTbH - 1} p [ - 1 - refIdx ] [ {y}^{′} ] + ( nTbH >> 1 ) ) >> Log 2 ( nTbH ) \qquad ( 325 )$$

2. The prediction samples predSamples[x][y] are derived as follows:

$$predSamples [ x ] [ y ] = dc Val , \qquad ( 326 )$$

$$with x = 0 … nTbW - 1 , y = 0 … nTbH - 1$$

### 8.4.5.2.13 Specification of INTRA_ANGULAR2 . . . . INTRA_ANGULAR66 Intra Prediction Modes

Inputs to this process are:
the intra prediction mode predModelIntra,
a variable refIdx specifying the intra prediction reference line index,
a variable nTbW specifying the transform block width,
a variable nTbH specifying the transform block height,
a variable refW specifying the reference samples width,
a variable refH specifying the reference samples height,
a variable nCbW specifying the coding block width,
a variable nCbH specifying the coding block height,
a variable refFilterFlag specifying the value of reference filter flag,
a variable cIdx specifying the colour component of the current block,
the neighbouring samples p[x][y], with x=−1−refIdx, y=−1−refIdx . . . refH−1 and x=−refIdx . . . refW−1, y=−1-refIdx.

Outputs of this process are the predicted samples predSamples[x][y], with x=0 . . . nTbW−1, y=0 . . . nTbH−1.

The variable nTbS is set equal to (Log 2(nTbW)+Log 2(nTbH))»1.

The variable filterFlag is derived as follows:
If one or more of the following conditions are true, filterFlag is set equal to 0:
   refFilterFlag is equal to 1;
   refIdx is not equal to 0;
   IntraSubPartitionsSplitType is not equal to ISP_NO_SPLIT.
Otherwise, the following applies:
   The variable minDistVerHor is set equal to Min(Abs(predModeIntra−50), Abs(predModeIntra−18)).
The variable intraHorVerDistThres[nTbS] is specified in Table 23.
The variable filterFlag is derived as follows:
   If minDistVerHor is greater than intraHorVerDistThres[nTbS], filterFlag is set equal to 1.
   Otherwise, filterFlag is set equal to 0.

TABLE 23
Specification of intraHorVerDistThres[nTbS]
for various transform block sizes nTbS

| | nTbS = | nTbS = | nTbS = | nTbS = | nTbS = |
|---|---|---|---|---|---|
| | 2 | 3 | 4 | 5 | 6 |
| intraHorVerDistThres[nTbS] | 24 | 14 | 2 | 0 | 0 |

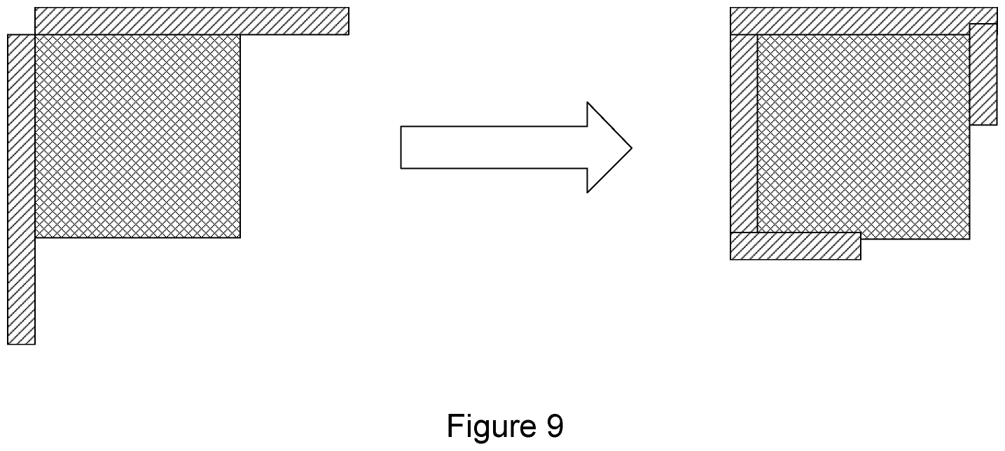

FIG. 9 illustrates the 93 prediction directions, where the dashed directions are associated with the wide-angle modes that are only applied to non-square blocks.

### Temporal Intra Prediction

In order to improve the intra prediction, we introduce temporal intra prediction. Instead of relying on reference samples available around the current block, it uses reference samples in a reference frame. In order to get reliable reference samples, a motion compensation is introduced.

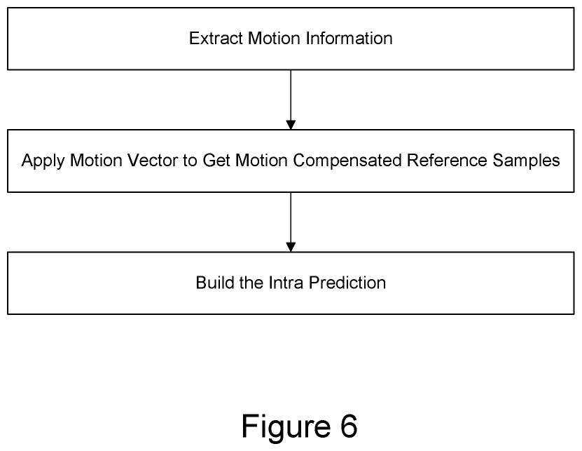

Note: in the following, we keep calling the prediction an “intra” prediction in order to point out the fact that the prediction process is very similar to the one of a regular intra prediction after the reference samples have been defined (last step in FIG. 6). However, it is understood that the prediction is technically an “inter” prediction since it uses a reference frame different from the current frame.

The new temporal intra prediction follow the process in FIG. 6.:
First a motion information is computed for the current block
Reference samples used in the intra prediction are constructed using a motion compensated version of the reference samples template.

### Motion Vector Derivation

### Global Motion Model

As the first B-frame (after the initial I-frame) contains more intra coded block and fewer motion information, a global motion information is sent at the slice level. Typically, at least one global motion model is computed at encoder and sent in the slide header (or picture header).

Typical methods to compute a global motion are:
Perform a block matching between the reference frame and the current frame and extract the dominant motion
Extract salient points (for example Harris corners or SIFT points) and match them robustly according to a common motion model (for example using the RANSAC)

The motion model can be an affine 4, affine 6 or homographic model for example. Alternatively, several models can be transmitted. Advantageously, the model parameters can be sent as the motion of the corner of the frame, coded differentially:
Top-left corner: sent as a motion vector using mvd encoding of the codec
Top-right corner: send the mvd of the difference between the motion of the top-right and the motion of the top-left already decoded
Bottom-left: same as top-right
Bottom-right: mvd of the difference between the bottom-right motion and the average of the top-left and bottom-left motion vector

From the global motion model, the motion of the current block is computed, for example using the motion of the center of the block. Alternatively, top-left or other location can be used to compute the motion of the block.

In case several models are available, an index of the model to use is signaled for the block using this mode. Advantageously, a context-based coding using neighboring block (typically top and left blocks) can be used to reduce the cost of signaling the index.

### Variant on Motion Derivation

Another way to get the motion information is to use the same process as the one used in inter coded blocks to deduce the motion. Typically, a list of probable motion vector candidates is computed, using a process similar to the merge inter list creation for example. The first candidate of the list is then used to infer the motion of the current block.

Alternatively, an index of the candidate to use to infer the motion is sent.

Alternatively, a template-based re-ordering similar to ARMC-TM is used to select the most probable candidate in the list.

### Variant on the Collocated Frame

In a variant, the collocated frame used as a reference frame for the motion vector is signaled in the slice header. Alternatively, the index is signaled at block level, the same way reference frame index is signaled in inter coded blocks.

### Reference Samples Construction

Once a motion vector is available, the reference samples can be constructed.

Contrarily to a regular intra prediction where some reference samples may be not available because of the causal nature of the decoding, in the case of a temporal intra prediction (TIP), all reference samples are available (except when samples are out of the frame or slice).

In order to create the array of reference samples, the motion vector decoded at the previous stage is applied to the collocated block position.

### Pel Motion Compensation and Smoothing Adaptation

In a variant, in order to reduce the complexity, the motion compensation is done pixel wise.

However, as the reference samples are filtered (for example using a Gaussian filter as depicted in 8.4.5.2.10 Reference sample filtering process), the sub-pixel motion compensation filter and Gaussian filtering stages can be done in 1 stage.

In a variant, horizontal reference samples (corresponding to the top neighbors in the block) are only filtered in the horizontal direction, i.e., the sub-pixel motion compensation filter and the Gaussian filter are applied only horizontally. The same logic applies to the vertical samples.

In a variant, the resulting filter of the sub-pixel motion compensation and Gaussian filtering is reduced to 3 taps, giving the same complexity than current intra smoothing of reference samples.

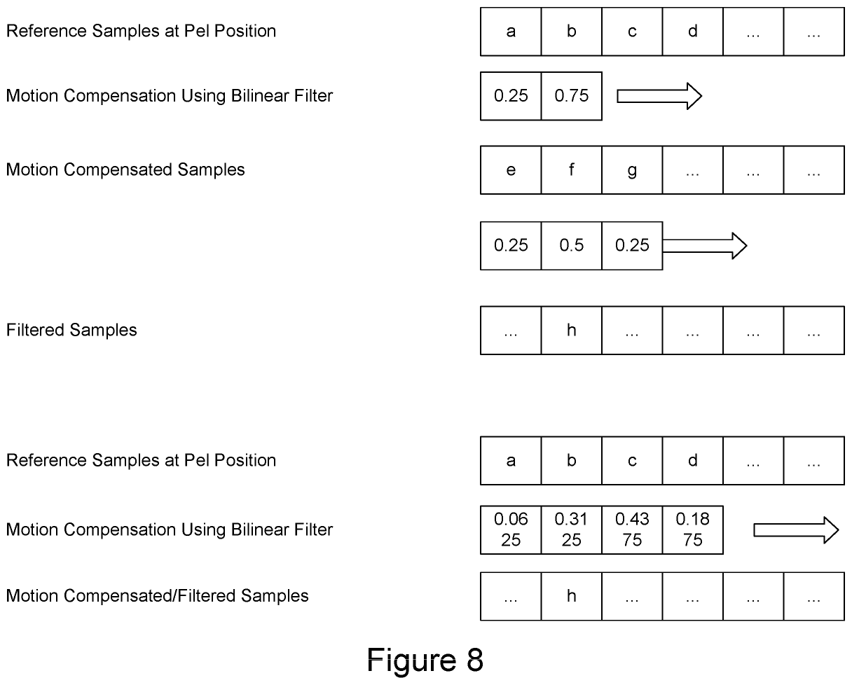

We give an example for a sub-pixel motion of ¼ pixel using a bilinear filter and a Gaussian filter with 3-tap in FIG. 8.

In a variant, both directions are filtered, requiring more reference samples to perform the full reference samples construction.

### Negative Angles Prediction

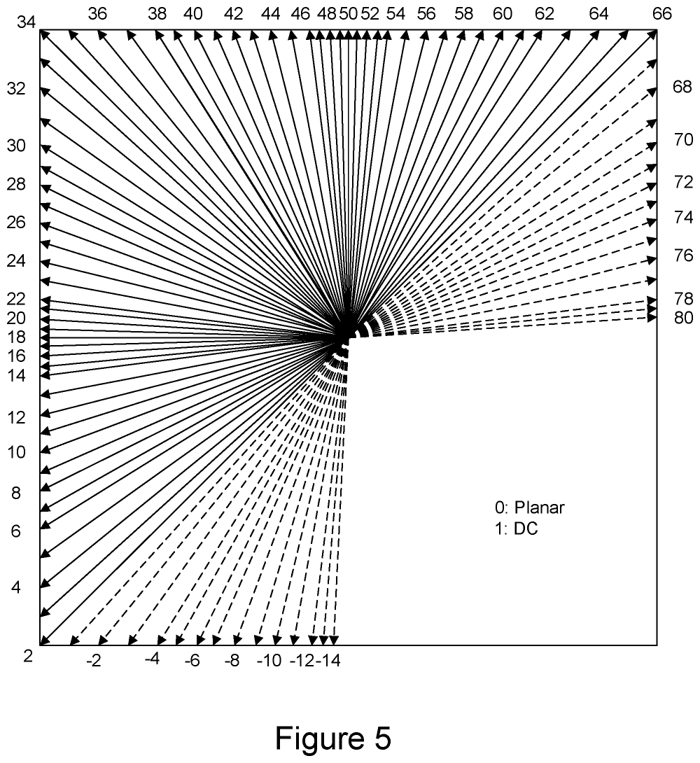

As all reference samples, around the blocks are available, some directions can used reference samples closer to the block than in regular intra prediction. Typically, negative directions and directions above 66 (see FIG. 5) use new reference samples as depicted in FIG. 9.

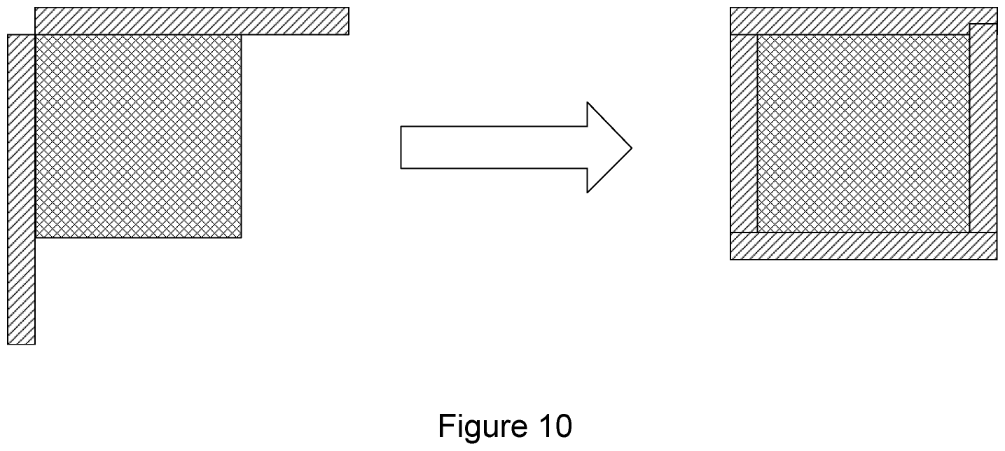

In another variant, new intra direction are available as depicted in FIG. 10. Sixteen new negative directions are added (i.e. the last direction is −30), and 15 new directions after 80 (up to 95) are added.

In another variant, MIP modes are also extended to take into account the newly available samples.

### Full Planar Mode

As all reference samples, around the blocks are available, the planar mode can take advantage of this.

Typically, the original process:

The values of the prediction samples predSamples[x][y], with x=0 . . . nTbW−1 and y=0 . . . nTbH−1, are derived as follows:

$$predV [ x ] [ y ] = ( ( nTbH - 1 - y ) * p [ x ] [ - 1 ] + ( y + 1 ) * p [ - 1 ] [ nTbH ] ) << Log 2 ( nTbW ) \qquad ( 320 )$$

$$predH [ x ] [ y ] = ( ( nTbW - 1 - x ) * p [ - 1 ] [ y ] + ( x + 1 ) * p [ nTbW ] [ - 1 ] ) << Log 2 ( nTbH ) \qquad ( 321 )$$

$$predSamples [ x ] [ y ] = ( predV [ x ] [ y ] + predH [ x ] [ y ] + nTbW * nTbH ) >> ( Log 2 ( nTbW ) + Log 2 ( nTbH ) + 1 )$$

is replaced by:

The values of the prediction samples predSamples[x][y], with x=0 . . . nTbW−1 and y=0 . . . nTbH−1, are derived as follows:

$$predV [ x ] [ y ] = ( ( nTbH - 1 - y ) * p [ x ] [ - 1 ] + ( y + 1 ) * p [ - 1 ] [ nTbH ] ) << Log 2 ( nTbW ) \qquad ( 320 )$$

$$predH [ x ] [ y ] = ( ( nTbW - 1 - x ) * p [ - 1 ] [ y ] + ( x + 1 ) * p [ nTbW ] [ - 1 ] ) << Log 2 ( nTbH ) \qquad ( 321 )$$

$$predSamples [ x ] [ y ] = ( predV [ x ] [ y ] + predH [ x ] [ y ] + nTbW * nTbH ) >> ( Log 2 ( nTbW ) + Log 2 ( nTbH ) + 1 )$$

Where the reference samples values p[x][y] are now accessible for bottom (p[x][nTbH]) and right parts (p[nTbW][y]).

### Full DC Mode

Using the same reference samples, the DC value can also be adapted:

1. A variable dcVal is derived as follows:
When nTbW is equal to nTbH:

$$dc Val = ( {\sum }_{{x}^{′} = 0}^{nTbW - 1} p [ {x}^{′} ] [ - 1 - refIdx ] + p [ {x}^{′} ] [ nTbH + refIdx ] {\sum }_{{y}^{′} = 0}^{nTbH - 1} p [ - 1 - refIdx ] [ {y}^{′} ] + p [ nTbW + refIdx [ {y}^{′} ] + nTbW << 1 ) >> ( Log 2 ( nTbW ) + 2 ) \qquad ( 323 )$$

When nTbW is greater than nTbH:

$$dc Val = ( {\sum }_{{x}^{′} = 0}^{nTbW - 1} p [ {x}^{′} ] [ - 1 - refIdx ] + p [ {x}^{′} ] [ nTbH + refIdx ] + ( nTbW ) ) >> ( Log 2 ( nTbW ) + 1 ) \qquad ( 324 )$$

When nTbW is less than nTbH:

$$dc Val = ( {\sum }_{{y}^{′} = 0}^{nTbH - 1} p [ - 1 - refIdx ] [ {y}^{′} ] + p [ nTbW + refIdx [ {y}^{′} ] + ( nTbH ) ) >> ( Log 2 ( nTbH ) + 1 ) \qquad ( 325 )$$

### Inner Reference Samples Temporal Intra Mode

As reference samples are also available inside the block, they can be used to give a better prediction (note: which is again technically an inter prediction but it does not try to accurately predict each pixel of the block).

### Inner Samples Template Prediction

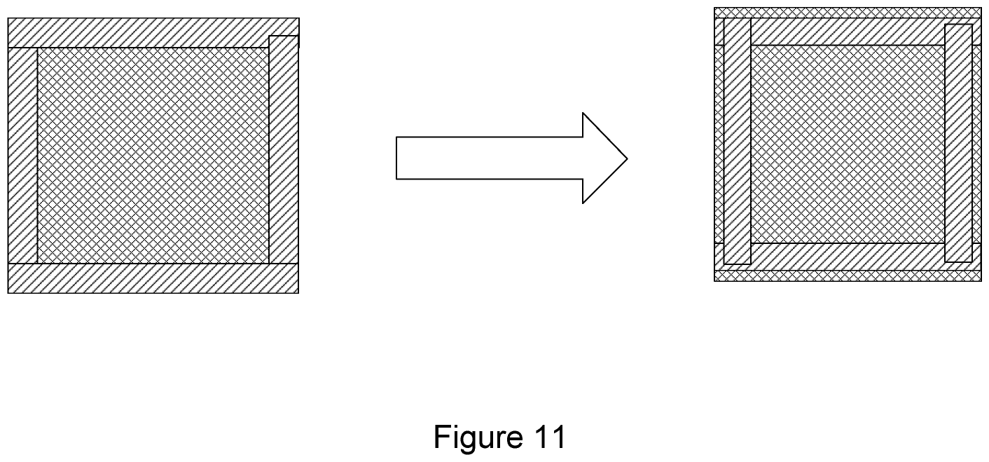

In a variant, all the intra reference samples are taken as in a regular prediction but on the inner side of the border of the block instead of the outer side as depicted in FIG. 11.

As an example, the planar mode becomes:

The values of the prediction samples predSamples[x][y], with x=0 . . . nTbW−1 and y=0 . . . nTbH−1, are derived as follows:

$$predV [ x ] [ y ] = ( ( nTbH - y ) * p [ x ] [ 0 ] + ( y ) * p [ x ] [ nTbH - 1 ] ) << Log 2 ( nTbW ) \qquad ( 320 )$$

$$predV [ x ] [ y ] = ( ( nTbW - x ) * p [ 0 ] [ y ] + ( x ) * p [ nTbW - 1 ] [ y ] ) << Log 2 ( nTbH ) \qquad ( 321 )$$

$$predSamples [ x ] [ y ] = ( predV [ x ] [ y ] + predH [ x ] [ y ] + nTbW * nTbH ) >> ( Log 2 ( nTbW ) + Log 2 ( nTbH ) + 1 )$$

### Full Inner Samples Prediction

A more generic variant is to use all samples of the block. However, the goal of the prediction is NOT to give an accurate prediction of the inner of the block (otherwise, inter based mode would have been selected).

In order to create such a mode, a prediction similar to MIP is created: reference samples are put in a vector and a linear function (matrix vector multiplication) is computed to create prediction samples (or subset of prediction samples).
Matrices are learnt to predict a block from inner samples
Dataset is created by using intra block from encoding of a dataset, for which a motion vector is inferred using a method as described earlier. Compensated blocks which are too different from the original blocks (according to some threshold) are not used in the dataset.
As in MIP, a subset of the prediction is created and linear interpolation is used to fill the whole prediction in order to limit the complexity.
For the same reason, not all samples are used during the matrix vector multiplication but only a subset of the samples or a subsampled version of the block.

### Signaling

### Block Level

The table below shows an extract of the decoding of a coding unit, specifically the intra mode decoding. A flag is added at top of the intra syntax to signal the use of the temporal intra prediction. In the example below, we assume that the temporal predictor used is inferred (for example using the global motion model). The same syntax as before to describe the intra prediction is kept, but the mode will apply to the displaced block.

### Coding Unit Syntax

The coding unit decoding contains a new syntax element related to the temporal intra prediction. When true, the remainder of the intra direction is slightly changed (using the intra_luma_mpm_remainder_ext) in order to take into account added negative directions. The final syntax is shown below:

| | |
|---|---|
| if( CuPredMode[ chType ][ x0 ][ y0 ] = = MODE_INTRA \|\| | |
| CuPredMode[ chType ][ x0 ][ y0 ] = = MODE_PLT ) { | |
| if( treeType = = SINGLE_TREE \|\| treeType = = DUAL_TREE_LUMA ) { | |
| if( pred_mode_plt_flag ) | |
| palette_coding( x0, y0, cbWidth, cbHeight, treeType ) | |
| else { | |
| if( sps_bdpcm_enabled_flag && | |
| cbWidth <= MaxTsSize && cbHeight <= MaxTsSize ) | |
| intra_bdpcm_luma_flag | ae(v) |
| if( intra_bdpcm_luma_flag ) | |
| intra_bdpcm_luma_dir_flag | ae(v) |
| else { | |
| if( sps_temporal_intra_prediction_enabled_flag ) | |
| intra_temporal_prediction_flag | ae(v) |
| if( sps_mip_enabled_flag) | |
| intra_mip_flag | ae(v) |
| if( intra_mip_flag ) { | |
| intra_mip_transposed_flag[ x0 ][ y0 ] | ae(v) |
| intra_mip_mode[ x0 ][ y0 ] | ae(v) |
| } else { | |
| if( sps_mrl_enabled_flag && ( ( y0 % CtbSizeY ) > 0 ) ) | |
| intra_luma_ref_idx | ae(v) |
| if( sps_isp_enabled_flag && intra_luma_ref_idx = = 0 && | |
| ( cbWidth <= MaxTbSizeY && cbHeight <= MaxTbSizeY ) && | |
| ( cbWidth * cbHeight > MinTbSizeY * MinTbSizeY ) && | |
| !cu_act_enabled_flag ) | |
| intra_subpartitions_mode_flag | ae(v) |
| if( intra_subpartitions_mode_flag = = 1 ) | |
| intra_subpartitions_split_flag | ae(v) |
| if( intra_luma_ref_idx = = 0 ) | |
| intra_luma_mpm_flag[ x0 ][ y0 ] | ae(v) |
| if( intra_luma_mpm_flag[ x0 ][ y0 ] ) { | |
| if( intra_luma_ref_idx = = 0 ) | |
| intra_luma_not_planar_flag[ x0 ][ y0 ] | ae(v) |
| if( intra_luma_not_planar_flag[ x0 ][ y0 ] ) | |
| intra_luma_mpm_idx[ x0 ][ y0 ] | ae(v) |
| } else { | |
| if (intra_temporal_prediction_flag) | |
| intra_luma_mpm_remainder_ext[ x0 ][ y0 ] | ae(v) |
| else | |
| intra_luma_mpm_remainder[ x0 ][ y0 ] | ae(v) |
| } | |
| } | |
| } | |
| } | |
| } | |

### Slice Level

At slice/picture/sequence level, a flag signaled if the temporal prediction is used for example sps_intra_temporal_prediction_enabled_flag.

When at least one global motion model is used, the global motion model parameters are also transmitted, for example using the syntax below:

| | |
|---|---|
| sps_intra_temporal_enabled_flag | ae(v) |
| if (sps_intra_temporal_enabled_flag) { | |
| model_order | ae(v) |
| mvd_coding( cpmv_top_left ) | |
| if( model_order>1 ) | |
| mvd_coding( cpmv_top_right-cpmv_top_left ) | |
| if(model_order>2) | |
| mvd_coding( cpmv_bottom_left-cpmv_top_left ) | |
| if(model_order>3) | |
| mvd_coding( cpmv_bottom_right-(cpmv_top_right+cpmv_bottom_left)/2) | |

The syntax element model_order is an integer between 0 and 3 to control the order of the motion model (translational, affine 4, affine 6 or homographic).

In a variant the cpmv are coded differentially by predicting each corner using the already available corners and the associated model.

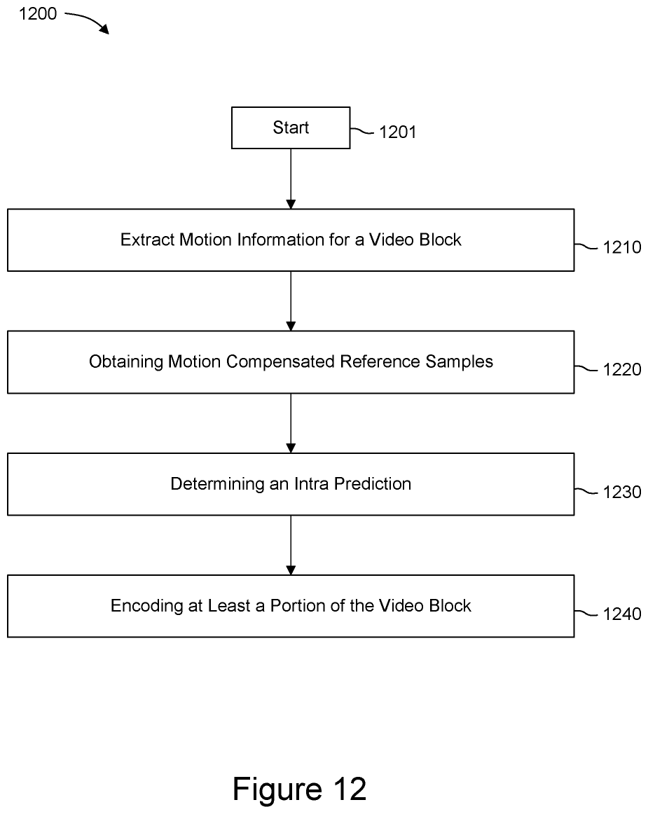

One embodiment of a method 1200 under the general aspects described here is shown in FIG. 12. The method commences at start block 1201 and control proceeds to block 1210 for extracting motion information for a video block. Control proceeds from block 1210 to block 1220 for obtaining motion compensated reference samples from the motion information for the video block. Control proceeds from block 1220 to block 1230 for determining an intra prediction from the motion compensated reference samples for the video block. Control proceeds from block 1230 to block 1240 for encoding at least a portion of the video block using the intra prediction.

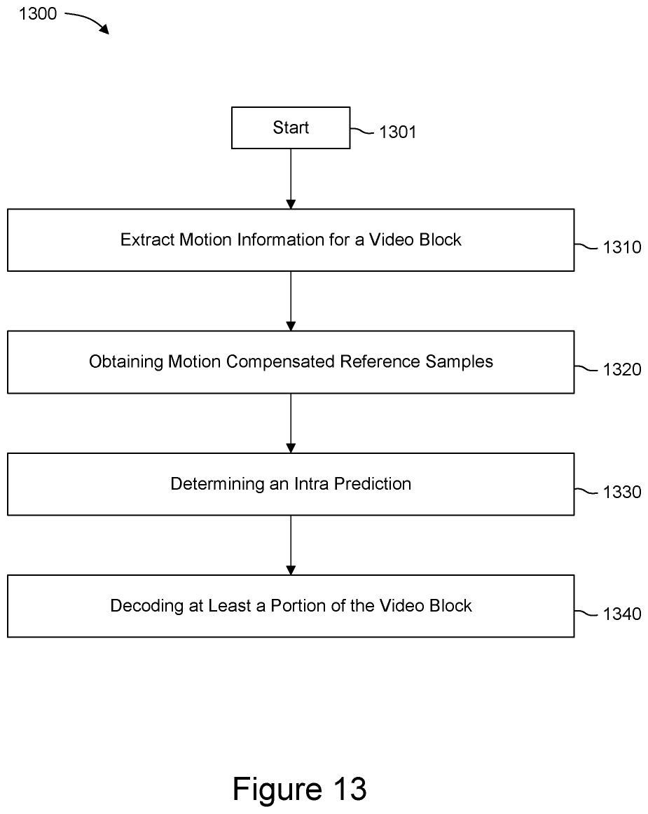

One embodiment of a method 1300 under the general aspects described here is shown in FIG. 13. The method commences at start block 1301 and control proceeds to block 1310 for extracting motion information for a video block. Control proceeds from block 1310 to block 1320 for obtaining motion compensated reference samples from the motion information for the video block. Control proceeds from block 1320 to block 1330 for determining an intra prediction from the motion compensated reference samples for the video block. Control proceeds from block 1330 to block 1340 for decoding at least a portion of the video block using the intra prediction.

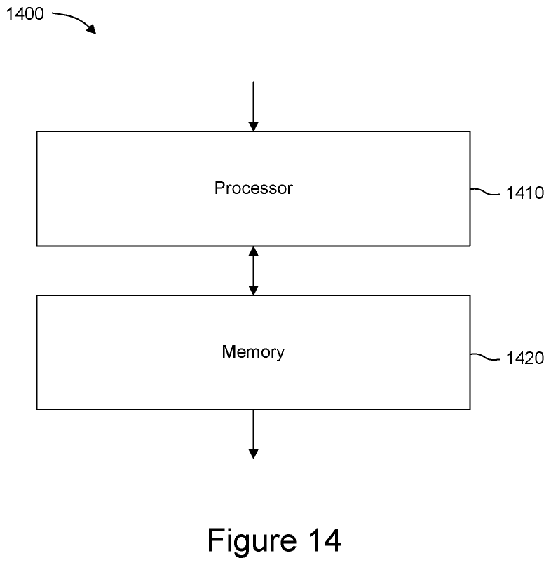

FIG. 14 shows one embodiment of an apparatus 1400 for encoding, decoding, compressing, or decompressing video data using any of the above methods, or variations. The apparatus comprises Processor 1910 and can be interconnected to a memory 1920 through at least one port. Both Processor 1910 and memory 1920 can also have one or more additional interconnections to external connections.

Processor 1410 is also configured to either insert or receive information in a bitstream and, either compressing, encoding, or decoding using any of the described aspects.

The embodiments described here include a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

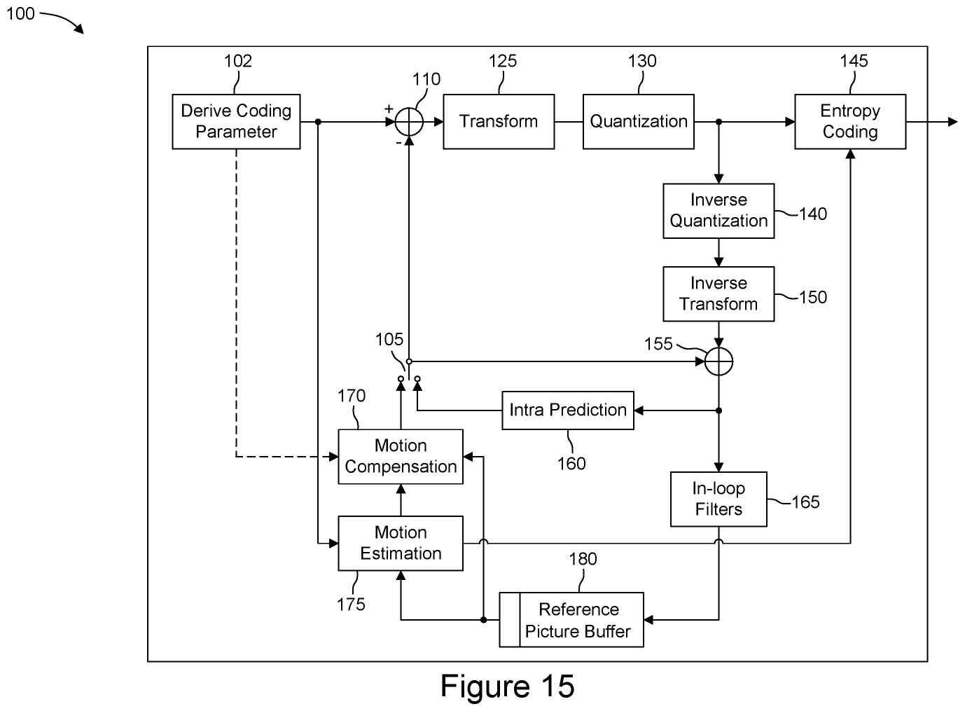

The aspects described and contemplated in this application can be implemented in many different forms. FIGS. 15, 16, and 17 provide some embodiments, but other embodiments are contemplated and the discussion of FIGS. 15, 16, and 17 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined.

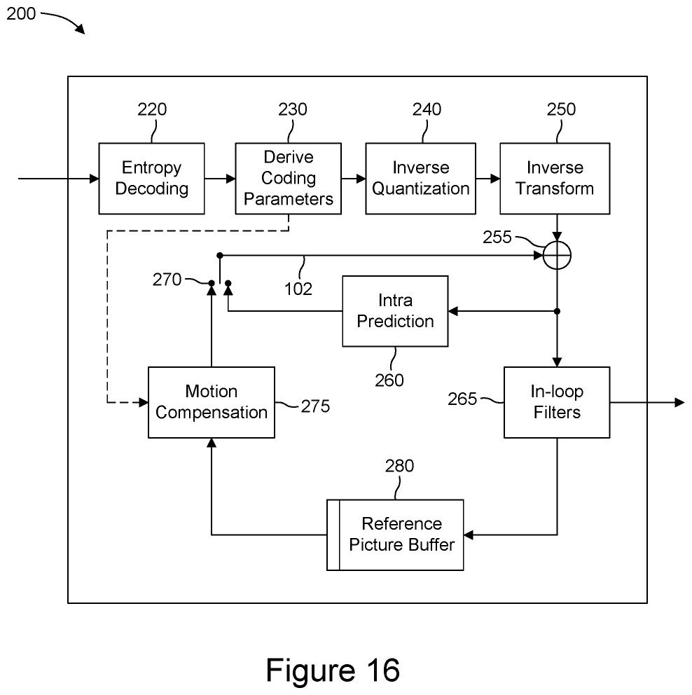

Various methods and other aspects described in this application can be used to modify modules, for example, the intra prediction, entropy coding, and/or decoding modules (160, 360, 145, 330), of a video encoder 100 and decoder 200 as shown in FIG. 15 and FIG. 16. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

FIG. 15 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset)/ALF (Adaptive Loop Filtering) filtering to reduce encoding artifacts. The filtered image is stored at a reference picture buffer (180).

FIG. 16 illustrates a block diagram of a video decoder 200. In the decoder 200, a bitstream is decoded by the decoder elements as described below. Video decoder 200 generally performs a decoding pass reciprocal to the encoding pass as described in FIG. 15. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g., conversion from YcbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

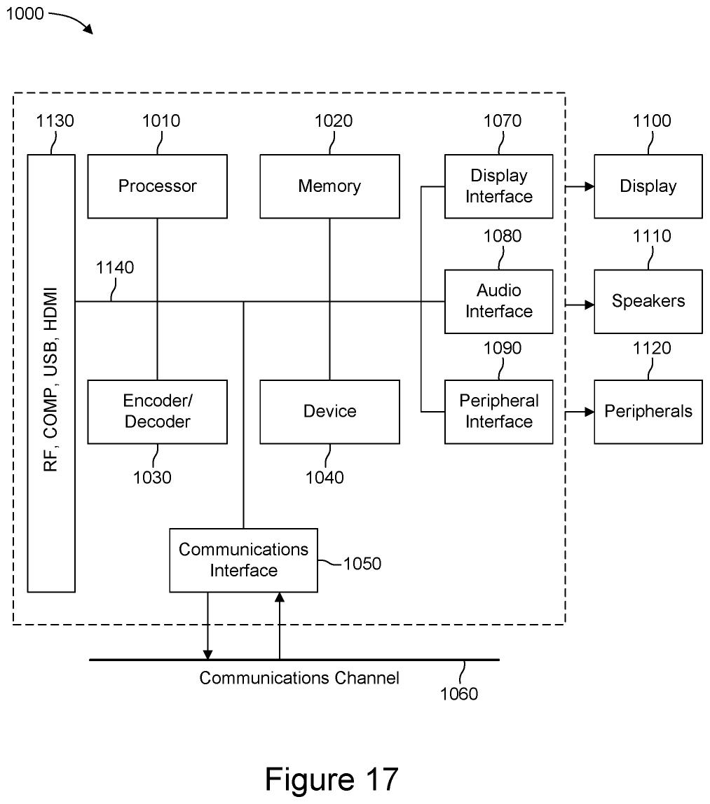

FIG. 17 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 17, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface Ics or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or another device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments may refer to parametric models or rate distortion optimization. In particular, during the encoding process, the balance or trade-off between the rate and distortion is usually considered, often given the constraints of computational complexity. It can be measured through a Rate Distortion Optimization (RDO) metric, or through Least Mean Square (LMS), Mean of Absolute Errors (MAE), or other such measurements. Rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of transforms, coding modes or flags. In this way, in an embodiment the same transform, parameter, or mode is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

The preceding sections describe a number of embodiments, across various claim categories and types. Features of these embodiments can be provided alone or in any combination. Further, embodiments can include one or more of the following features, devices, or aspects, alone or in any combination, across various claim categories and types:

One embodiment comprises predicting a video block using an intra coding mode and reference samples from a temporally collocated reference frame.

One embodiment comprises using a intra prediction motion model to predict samples from a reference frame.

One embodiment comprises the above method wherein an intra coding mode is determined at an encoder and the mode and/or the reference frame is signaled to a corresponding decoder.

One embodiment comprises the above method wherein different motion models are used to determine a reference frame or a motion vector.

One embodiment comprises any of the above methods wherein an index is signaled to indicate a motion model, reference frame, or motion vector to be used for encoding/decoding.

One embodiment comprises any of the above methods using reference samples around a motion compensated block from a reference frame.

One embodiment comprises a bitstream or signal that includes one or more syntax elements to perform the above functions, or variations thereof.

One embodiment comprises a bitstream or signal that includes syntax conveying information generated according to any of the embodiments described.

One embodiment comprises creating and/or transmitting and/or receiving and/or decoding according to any of the embodiments described.

One embodiment comprises a method, process, apparatus, medium storing instructions, medium storing data, or signal according to any of the embodiments described.

One embodiment comprises inserting in the signaling syntax elements that enable the decoder to determine decoding information in a manner corresponding to that used by an encoder.

One embodiment comprises creating and/or transmitting and/or receiving and/or decoding a bitstream or signal that includes one or more of the described syntax elements, or variations thereof.

One embodiment comprises a TV, set-top box, cell phone, tablet, or other electronic device that performs transform method(s) according to any of the embodiments described.

One embodiment comprises a TV, set-top box, cell phone, tablet, or other electronic device that performs transform method(s) determination according to any of the embodiments described, and that displays (e.g. using a monitor, screen, or other type of display) a resulting image.

One embodiment comprises a TV, set-top box, cell phone, tablet, or other electronic device that selects, bandlimits, or tunes (e.g. using a tuner) a channel to receive a signal including an encoded image, and performs transform method(s) according to any of the embodiments described.

One embodiment comprises a TV, set-top box, cell phone, tablet, or other electronic device that receives (e.g. using an antenna) a signal over the air that includes an encoded image, and performs transform method(s).

1. A method, comprising:
extracting motion information for a video block;
obtaining motion compensated reference samples from the motion information for the video block;
determining an intra prediction from the motion compensated reference samples for the video block; and
encoding at least a portion of the video block using the intra prediction.

2. An apparatus, comprising:
a processor, configured to perform:
extracting motion information for a video block;
obtaining motion compensated reference samples from the motion information for the video block;
determining an intra prediction from the motion compensated reference samples for the video block; and
encoding at least a portion of the video block using the intra prediction.

3. A method, comprising:
extracting motion information for a video block;
obtaining motion compensated reference samples from the motion information for the video block;
determining an intra prediction from the motion compensated reference samples for the video block; and
decoding at least a portion of the video block using the intra prediction.

4. An apparatus, comprising:
a processor, configured to perform:
extracting motion information for a video block;
obtaining motion compensated reference samples from the motion information for the video block;
determining an intra prediction from the motion compensated reference samples for the video block; and
decoding at least a portion of the video block using the intra prediction.

5. The method of claim 1, wherein said extracted motion information comprises a motion vector.

6. The method of claim 1, wherein said motion compensated reference samples are obtained from a reference frame.

7. The method of claim 6, wherein said reference frame is collocated to a frame comprising the video block.

8. The apparatus of claim 4, wherein, said motion information is determined by a motion model.

9. The apparatus of claim 8, wherein said motion model is computed in an encoder and sent to a corresponding decoder as header information.

10. The apparatus of claim 4, wherein reference samples from a reference frame can comprise samples around a block in a reference frame.

11. The apparatus of claim 4, wherein a reference collocated frame to use, or an index to a reference frame to use, is signaled.

12. A device comprising:
an apparatus according to claim 4; and
at least one of (i) an antenna configured to receive a signal, the signal including the video block, (ii) a band limiter configured to limit the received signal to a band of frequencies that includes the video block, and (iii) a display configured to display an output representative of the video block.

13. A non-transitory computer readable medium containing data content generated according to the method of claim 1, for playback using a processor.

14. (canceled)

15. A computer program product comprising instructions which, when the program is executed by a computer, cause the computer to carry out the method of claim 3.

16. The method of claim 3, wherein said extracted motion information comprises a motion vector.

17. The method of claim 3, wherein said motion compensated reference samples are obtained from a reference frame.

18. The method of claim 17, wherein said reference frame is collocated to a frame comprising the video block.

19. The apparatus of claim 4, wherein, said motion information is determined by a motion model.

20. The apparatus of claim 19, wherein said motion model is computed in an encoder and sent to a corresponding decoder as header information.

21. The apparatus of claim 4, wherein reference samples from a reference frame can comprise samples around a block in a reference frame.
